(19) United States
(12) Patent Application Publication
(10) Pub. No.: US 2015/0310536 A1
(43) Pub. Date: Oct. 29, 2015

(54) SYSTEMS AND METHODS FOR IN-STORE FULFILLMENT OF ONLINE PURCHASE ORDERS FOR CUSTOMIZED PRODUCTS

(71) Applicant: THINGS REMEMBERED, INC., Highland Heights, OH (US)

(72) Inventors: Clyde Brady, Wellington, OH (US); Anthony Chivari, Pepper Pike, OH (US); Wallace Dal Pan, Madison, OH (US); Constance Fumich, Chardon, OH (US); Donald Giddens, Wadsworth, OH (US); Joel Lancaster, Broadview Heights, OH (US); Mark Lilien, Highland Heights, OH (US); Vilena Parrish, Elyria, OH (US); Doug Van De Motter, Hudson Village, OH (US); Kevin Watt, Mentor, OH (US); Larry Wiseman, Streetsboro, OH (US)

(73) Assignee: THINGS REMEMBERED, INC., Highland Heights, OH (US)

(21) Appl. No.: 14/698,440

(22) Filed: Apr. 28, 2015

Related U.S. Application Data
(60) Provisional application No. 61/985,965, filed on Apr. 29, 2014.

(51) Int. Cl. G06Q 30/06

(52) U.S. Cl. CPC G06Q 30/0635; G06Q 30/0621

(57) ABSTRACT

A method of enabling in-store pick up of customized goods ordered online is described. The method may include receiving an online purchase order at a website including a customized product description and a brick-and-mortar store identifier. The method may also include sending the purchase order to a computing device associated with the brick-and-mortar store identifier and receiving an in-stock confirmation at the computing device. The method may also include receiving an order completed confirmation at the computing device and sending a customer correspondence that includes a pick-up time designating when a customer may pick up the customized product at the brick-and-mortar store. The method may also include receiving an in-store pick up confirmation at the computing device.

### CROSS-REFERENCE TO RELATED APPLICATIONS

Pursuant to 35 U.S.C. §119(e), this application claims priority from, and hereby incorporates by reference for all purposes, U.S. Provisional Patent Application Ser. No. 61/985,965, entitled “Systems and Methods for In-Store Fulfillment of Online Purchase Orders for Customized Products,” filed Apr. 29, 2014.

### BACKGROUND OF THE DISCLOSURE

Shoppers often desire to purchase customized goods that include unique or personalized features chosen and/or designed by the shopper. Customization choices can be made online via websites that offer customization options to a customer, such as engraved or embroidered symbols or words on an object. The customized product is created at a remote location associated with the website and is then shipped to the customer by mail. Unfortunately, this method of purchasing customized products requires a large lead time between customizing the good, purchasing the customized good online and then receiving the customized good in the mail. The speed of delivery in this method is inherently limited by the speed of the mail system that delivers the customized good. In order to receive the customized good within a shorter timeframe, it is often necessary to expedite shipping which increases the overall cost of the transaction. Therefore, there is a need for a system to expedite delivery of goods which are customized and ordered online without incurring increased shipping costs.

### SUMMARY

This summary is provided to introduce a selection of concepts in a simplified form that are further described below in the Detailed Description. Embodiments are directed to methods of enabling in-store pick up of customized goods that are customized and ordered online.

In a first aspect, there is provided a method, implemented in computer-executable program(s) or computer-executable instruction(s) in computer system(s) or device(s) that includes receiving an online purchase order including a customized product description and a brick-and-mortar store identifier and sending the online purchase order to a store portal server associated with the brick-and-mortar store identifier. The method also includes receiving an order received confirmation and an in-stock confirmation from the store portal server and receiving an order completed confirmation from the store portal server. The method may also include sending a customer correspondence to a customer computing device, wherein the customer correspondence includes a product completed confirmation. In addition, the method may include receiving an in-store pick up confirmation from the store portal server.

In some embodiments, the method includes sending an estimated completion time to the customer computing device before receiving the online purchase order.

In other embodiments, the method includes sending an estimated completion time to the customer computing device after receiving the online purchase order.

In yet other embodiments, receiving an online purchase order includes a phrase for engraving on a product associated with the customized product description.

In still other embodiments, receiving an online purchase order includes receiving one or more designs for engraving on a product associated with the customized product description.

In other embodiments, receiving an online purchase order includes receiving an un-customized product selection.

In still other embodiments, the method includes receiving a customer location and determining one or more store identifiers within a specified geographic distance of the customer location.

In another embodiment, the method includes calculating an estimated pickup time that is within operating hours of a brick-and-mortar store associated with the brick-and-mortar store identifier.

In a further embodiment, the method includes calculating an estimated pickup time based on a time to complete customization associated with the customized product description.

In a second aspect, there is described a method of enabling in-store pickup of customized goods ordered online that includes receiving an un-customized product selection from a web server and receiving a customer location from the web server. The method also includes sending data associated with one or more brick-and-mortar stores within a geographic distance of the customer location that have the un-customized product in stock to the web server. In some embodiments, the method includes receiving a brick-and-mortar store selection and customization instructions to create a customized product and sending the customization instructions to a store portal server associated with the selected brick-and-mortar store. The method may also include receiving an order received confirmation and an in-stock confirmation from the store portal server.

In some embodiments, the method includes receiving a product customization complete confirmation from the store portal server.

In other embodiments, the method includes sending a customer correspondence that includes a product ready indication to a customer computing device.

In still other embodiments, the method includes receiving a product pick up confirmation from the store portal server when a customer picks up a customized product.

In yet other embodiments, the method includes sending an estimated completion time to a customer computing device.

In additional embodiments, the method includes calculating the estimated completion time based on the customized product.

In a third aspect, there is described a method of enabling in-store pickup of customized goods ordered online that includes receiving an un-customized product selection at a website server and receiving a customizing selection for the un-customized product at the website server. The method also includes receiving a user location designation at the website server and sending data concerning one or more brick-and-mortar store identifiers that have the un-customized product in stock and are within a specified geographic distance of the user location designation to the website server. The method also includes customizing an un-customized product associated with the un-customized product selection to include the customizing selection and sending an order ready for pick-up message to a user computer device.

In some embodiments, the method includes receiving at an inventory server a product in stock confirmation from a brick-and-mortar store associated with the brick-and-mortar store identifier.

In other embodiments, customizing the un-customized product includes etching the un-customized product.

In yet other embodiments, customizing the un-customized product includes embroidering the un-customized product.

In some embodiments, the method includes calculating an estimated pickup time that is within operating hours of a brick-and-mortar store associated with the brick-and-mortar store identifier.

### DESCRIPTION OF THE FIGURES

The accompanying drawings facilitate an understanding of the various embodiments.

FIG. 1 is a block diagram of an exemplary operating environment for use in implementing an embodiment or a portion of an embodiment of the present disclosure.

FIG. 2 is a block diagram of a network environment for use in implementing an embodiment of the present disclosure.

FIGS. 3A and 3B are a flowchart illustrating a process for in-store pick up of customized goods ordered online in accordance with this disclosure.

FIG. 4 is an exemplary display of a graphical user interface for a web browser displaying brick-and-mortar store locations in accordance with this disclosure.

FIG. 5 is an exemplary display of a graphical user interface for a web browser displaying customization options in accordance with this disclosure.

FIG. 6 is an exemplary display of a graphical user interface for a store portal in accordance with this disclosure.

FIG. 7 is an exemplary order detail sheet in accordance with this disclosure.

FIG. 8 is an exemplary display of a graphical user interface for a store portal in accordance with this disclosure.

FIG. 9 is an exemplary customer order form in accordance with this disclosure.

FIGS. 10-12 are exemplary displays of a graphical user interface for a store portal in accordance with this disclosure.

FIG. 13 is a flow chart illustrating a process for in-store pick up of customized goods ordered online carried out by an inventory server in accordance with this disclosure.

FIG. 14 is a flow chart illustrating a process for in-store pick up of customized goods ordered online carried out by a store portal server in accordance with this disclosure.

### DETAILED DESCRIPTION

Online shoppers often desire to purchase customized goods, such as goods that include engravings or other personalized aspects, on an online website and then receive the customized good quickly without incurring increased shipping charges. Therefore, there is a need for a way to expedite delivery of personalized goods which are ordered online without incurring increased shipping costs.

Embodiments described herein generally relate to a new method for delivering customized goods to a customer without incurring increased shipping costs and without extensive time delay due to traditional shipping methods. In one embodiment, a customer customizes a product on a webpage and places an order for the customized product. The web page displays a list or map of brick-and-motor stores at which the un-customized product chosen by the customer is in stock according to near real-time inventory data. The customer selects a brick-and-motor store, presumably the brick-and-motor store that is geographically closest to the customer, and an order is sent to the store. The store confirms that the un-customized product is in stock at the store and then customizes the product in accordance with the customer's customization choices. When the customized product is complete, the store confirms that the customized product is ready for pickup and the customer receives a communication on a computing device, such as a smart phone, stating that the customized product is ready for pickup. In some embodiments, the customized product is ready for pick up within four hours of receipt of the customer's online order. The customer picks up the customized good at the brick-and-mortar store and the portal and inventory systems are updated accordingly.

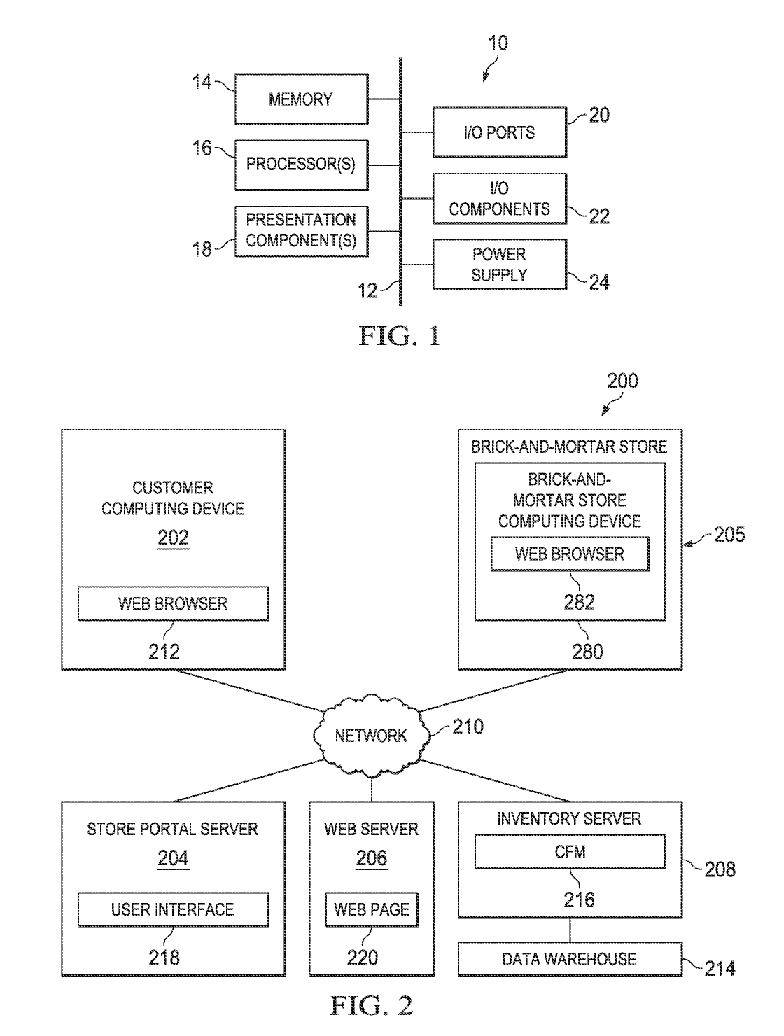

Having described a general overview of the embodiments described herein, an exemplary operating environment is described below. Referring initially to FIG. 1 in particular, an exemplary operating environment for implementing the present invention is shown and designated generally as computing device 10. The computing device 10 is but one example of a suitable computing environment and is not intended to suggest any limitations as to the scope of use or functionality of the disclosure. Neither should computing device 10 be interpreted as necessarily having any dependency or requirement relating to any one or combination of components illustrated. The disclosure may be described in the general context of a computer code or machine-usable instructions, including computer-executable instructions such as program modules, being executed by a computer or other machine, such as a PDA, smartphone or other handheld device. Generally, program modules that include routines, programs, objects, components, data structures, and the like, refer to code that perform particular tasks or implement particular abstract data types. The modules described herein may represent executable source code written in a well-known language, such as, for example, C, C++, C#, Java, or the like. Embodiments described herein may be practiced in distributed computing environments where tasks are performed by remote-processing devices that are linked through one or more communications networks.

With continued reference to FIG. 1, computing device 10 includes a bus 12 that directly or indirectly couples the following devices: memory 14, one or more processors 16, one or more presentation components 18, input/output ports 20, input/output components 22 and an illustrative power supply 24. Bus 12 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. It will be understood by those skilled in the art that such is the nature of the art, and, as previously mentioned, the diagram of FIG. 1 is merely illustrative of an exemplary computing device that can be used in connection with one or more embodiments of the present invention. Distinction is not made between such categories as “workstation,” “server,” “laptop,” “hand-held device,” “smartphone,” etc., as all are contemplated within the scope of FIG. 1 and reference to as a “computing device.”

The computing device 10 typically includes a variety of computer-readable media. By way of example, and not limitation, computer-readable media may comprise Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices, carrier wave or any other medium that can be used to encode desired information and be accessed by the computing device 10.

The memory 14 includes computer-storage media in the form of volatile and/or nonvolatile memory. The memory 14 may be removable, nonremovable, or a combination thereof. Exemplary hardware devices include solid-state memory, hard drives, cache, optical-disc drives, etc. The computing device 10 includes one or more processors 16 that read data from various entities such as memory 14 or I/O components 22. The presentation component(s) 18 present data indications to a user or other device. Exemplary presentation components 18 include a display device, speaker, printing component, vibrating component, etc.

The I/O ports 20 allow computing device 10 to be logically coupled to other devices including I/O components 22, some of which may be built in. Illustrative components include a microphone, joystick, game pad, satellite dish, scanner, printer, wireless device, keypad etc.

Turning now to FIG. 2, a block diagram depicting a networking architecture 200 is shown for use in implementing embodiments described herein. The networking architecture 200 includes a customer computing device 202, a store portal server 204, a web server 206, and an inventory server 208, all of which may communicate with each other via network 210. The networking architecture 200 is merely an example of one suitable networking environment and is not intended to suggest any limitation as to the scope of use or functionality of the present invention. Neither should networking architecture 200 be interpreted as necessarily having any dependency or requirement related to any single component or combination of components illustrated therein.

The client computing device 202 and the brick-and-mortar computing device 280 may be any type of computing device, such as device 10 described above with reference to FIG. 1. By way of example only and not limitation, the client computing device 202 and the brick-and-mortar computing device 280 may be a personal computer, desktop computer, laptop computer, handheld device, cellular phone, digital phone, smartphone, PDA, or the like. It should be noted that embodiments are not limited to implementation on such computing devices.

The network 210 may include any computer network or combination thereof. Examples of computer networks configurable to operate as network 210 include, without limitation, a wireless network, landline, cable line, digital subscriber line (DSL), fiber-optic line, local area network (LAN), wide area network (WAN), metropolitan area network (MAN), or the like. The network 210 is not limited, however, to connections coupling separate computer units. Rather, the network 210 may also include subsystems that transfer data between servers or computing devices. For example, the network 210 may also include a point-to-point connection, the Internet, an Ethernet, an electrical bus, a neural network, or other internal system.

In an embodiment where the network 210 comprises a LAN networking environment, components may be connected to the LAN through a network interface or adapter. In an embodiment where the network 210 comprises a WAN networking environment, components may use a modem, or other means for establishing communications over the WAN, to communicate. In embodiments where the network 210 comprises a MAN networking environment, components may be connected to the MAN using wireless interfaces or optical fiber connections. Such networking environments are commonplace in offices, enterprise-wide computer networks, intranets, and the Internet. It will be appreciated that the network connections shown are exemplary and other means of establishing a communications link between the computers may also be used.

Furthermore, the network 210 may also include various components necessary to facilitate communication with a mobile phone (e.g., cellular phone, Smartphone, Blackberry®). Such components may include, without limitation, switching stations, cell sites, Public Switched Telephone Network interconnections, hybrid fiber coaxial cables, or the like.

The store portal server 204 and the web server 206 may be any type of application server, database server, or file server configurable to perform the methods described herein. In addition, each of the servers 204, 206 and 208 may be a dedicated or shared server. One example, without limitation, of a server that is configurable to operate as the server 204 or 206 is a PowerEdge server manufactured by Dell, Inc. The servers 204 and 206 may also be configured to run server software, such as SQL Server 2005, which was developed by the Microsoft® Corporation, Apache HTTP Server Project, developed by the Apache Software Foundation, or some other proprietary server software, such as a proprietary IBM iseries server that will not run Microsoft software but runs software written in RPG that is compiled on an IBM operating system.

Components of the servers 204, 206 and 208 may include, without limitation, a processing unit, internal system memory, and a suitable system bus for coupling various system components, including one or more databases for storing information (e.g., files and metadata associated therewith). Each server may also include, or be given access to, a variety of computer-readable media. By way of example, and not limitation, computer-readable media may include computer-storage media and communication media. In general, communication media enables each server to exchange data via network 210. More specifically, communication media may embody computer-readable instructions, data structures, program modules, or other data in a modulated data signal, such as a carrier wave or other transport mechanism, and may include any information-delivery media. As used herein, the term “modulated data signal” refers to a signal that has one or more of its attributes set or changed in such a manner as to encode information in the signal. By way of example, and not limitation, communication media includes wired media such as a wired network or direct-wired connection, and wireless media such as acoustic, RF, infrared, and other wireless media. Combinations of any of the above also may be included within the scope of computer-readable media.

It will be understood by those of ordinary skill in the art that networking architecture 200 is merely exemplary. While the servers 204, 206 and 208 are illustrated as single boxes, one skilled in the art will appreciate that they may be scalable. For example, the servers 204, 206 and 208 may in actuality include multiple boxes in communication. The single unit depictions are meant for clarity, not to limit the scope of embodiments in any form.

The customer computing device 202 and the brick-and-mortar computing device 280 comprise web browsers 212 and 282, respectively, which are software applications enabling a user to display and interact with information located on a web page, such as web page 220 or user interface 218, which may be a password-protected web page or online portal for employees only. In an embodiment, the web browsers 212 or 282 may communicate with the store portal server 204, the web server 206, and other components accessible over the network 210. The web browsers 212 or 282 may locate web pages by sending a transferring protocol and the URL. The web browser 212 or 282 may use various URL types and protocols, such as hypertext transfer protocol (HTTP), file transfer protocol (FTP), real-time streaming protocol (RTSP), etc. The web browsers 212 and 282 may also understand a number of file formats—such as HTML, graphics interchange format (GIF), tagged image file format (TIFF), portable document format (PDF), or joint photographic experts group (PDF) file format, and the like—the wealth of which can be extended by downloaded plug-ins. Additionally, the web browsers 212 or 282 may be any browser capable of navigating the Web, such as Internet Explorer®, Netscape Navigator, Mozilla, Firefox, etc.

In operation, a customer accesses the web page 220 using the web browser 212 on the customer computing device 202. The web page 220 is stored on the web server 206, which is configured to transmit the HTML and other content associated with the web page 220 to the customer computing device 202. The web browser 212 is configured to render the web page 220 and display it to the user.

Similarly, a worker at a brick-and-mortar store 205 accesses the user interface 218, which may be a password-protected web page, using the web browser 282 on the brick-and-mortar store computing device 280. The user interface 218 is stored on the store portal server 204, which is configured to transmit the HTML and other content associated with the user interface 218 to the brick-and-mortar store computing device 280. The web browser 282 is configured to render the user interface 218 and display it to the worker.

In some embodiments, the inventory server 208 includes a central order and fulfillment management system (CFM) 216 and is connected to a data warehouse 214. In some embodiments, the store portal server 204 includes a user interface 218. In some embodiments, the store portal server 204 is located at a brick-and-mortar store 205 while in other embodiments the store portal server 204 is located remotely from the brick-and-mortar store 205. Thus, in some embodiments a worker at the brick-and-mortar store 205 accesses the store portal server 204 via a web browser 282, as illustrated in FIG. 2.

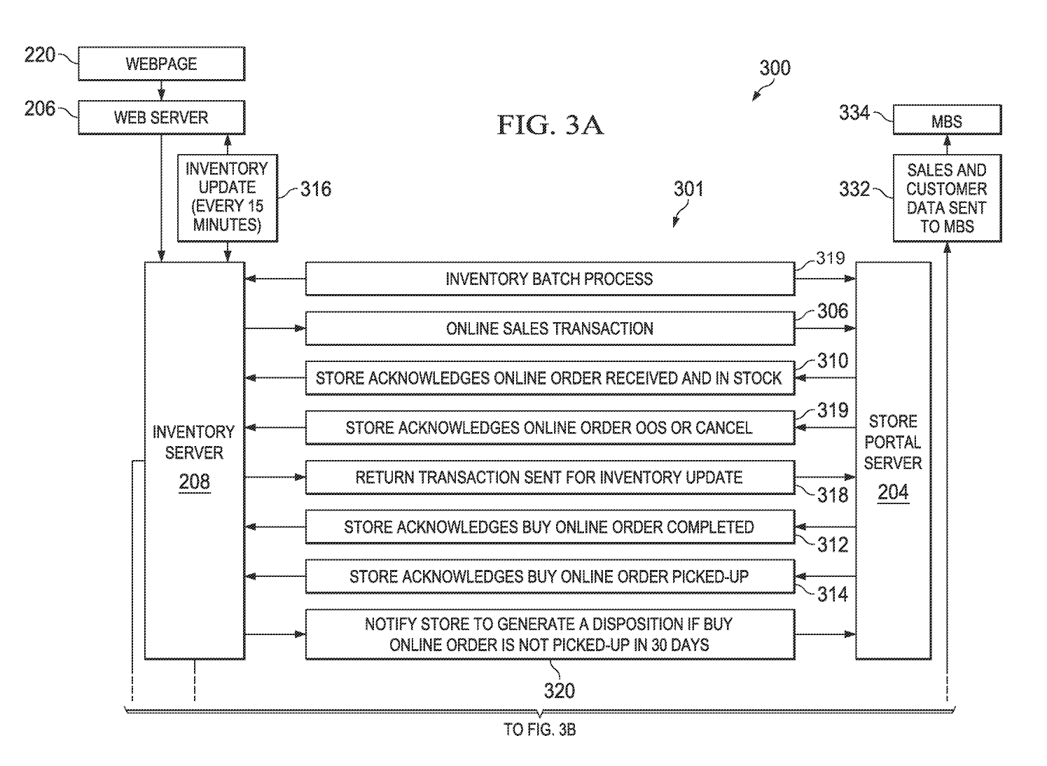

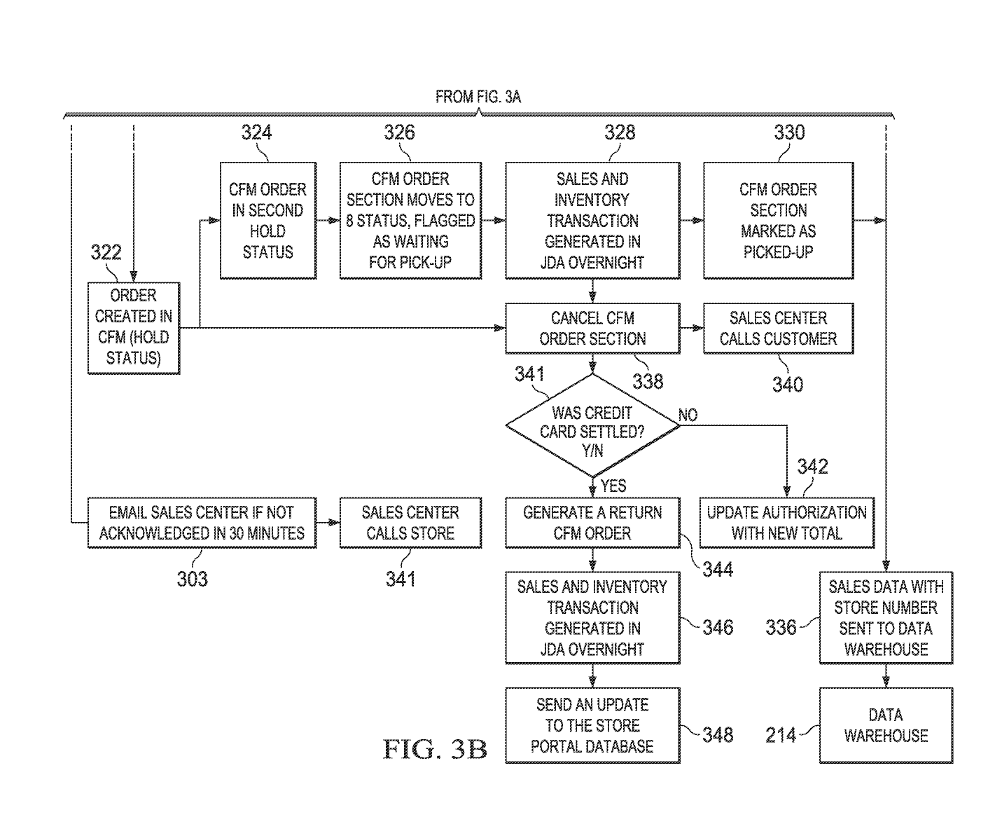

Turning now to FIGS. 3A and 3B, a flowchart is shown illustrating a process 300 for enabling in-store pickup of customized goods ordered by a customer via a webpage 220. In some embodiments, the customer uses a user computing device 202 to view the web page 220 via the web server 206. The customer selects an un-customized product from a menu of un-customized products on the webpage 302. The inventory server 208 communicates inventory statistics of a collection of brick-and-mortar stores 205 to the web server 206 at regular (or irregular) intervals so that the web server 206 and the web page 220 include up-to-date data concerning store inventory. In some embodiments, for example, the inventory server 208 communicates inventory data with the web server 206 every 15 minutes.

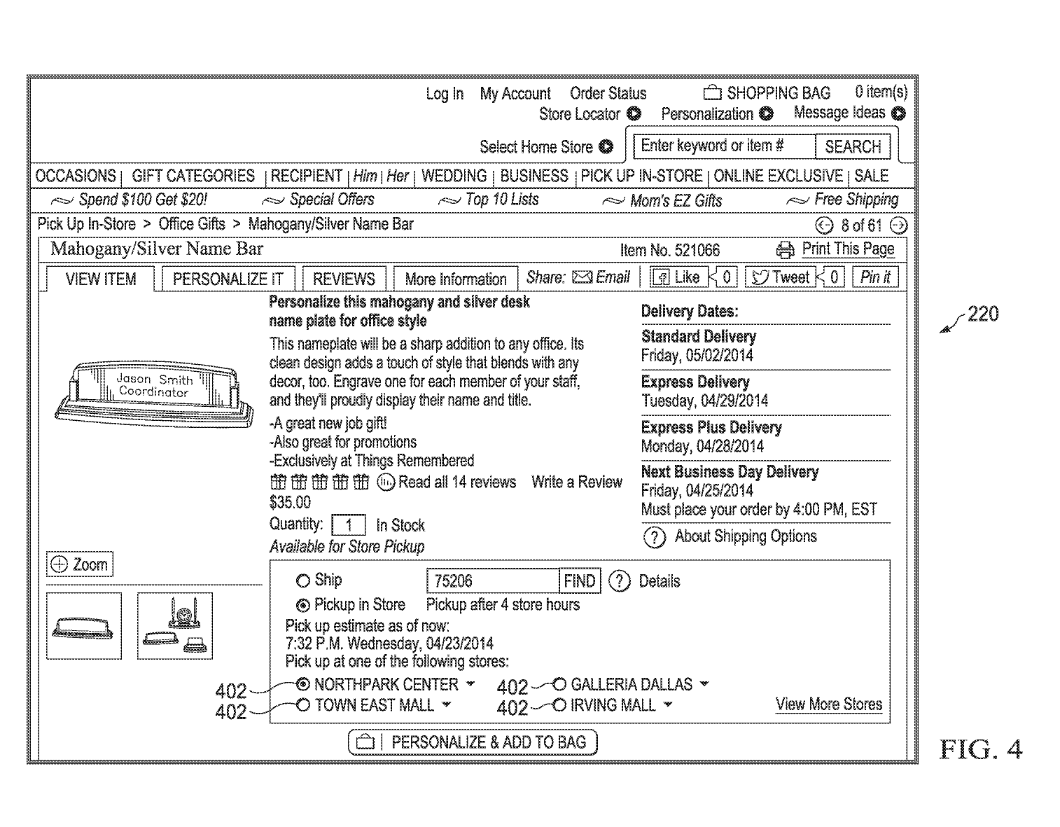

Based on the un-customized product chosen by the customer, the webpage 302 communicates with the web server 206 and/or the inventory server 304 to determine which brick-and-mortar stores 205 have the un-customized product in stock. In some embodiments, the user also submits a user location and the web server 206 or the inventory server 304 determines which brick-and-mortar stores that have the un-customized product in stock are within a selected geographic distance of the user location. The webpage 302 displays the brick-and-mortar stores that are near the customer and have the particular un-customized product in stock. As shown in FIG. 4, for example, one or more brick-and-mortar stores options 402 that have the particular un-customized product in stock and are within a specified geographic distance of the customer location are displayed on the webpage 220. The customer then has the opportunity to select a particular brick-and-mortar store 205 near the customer or near some other desired location.

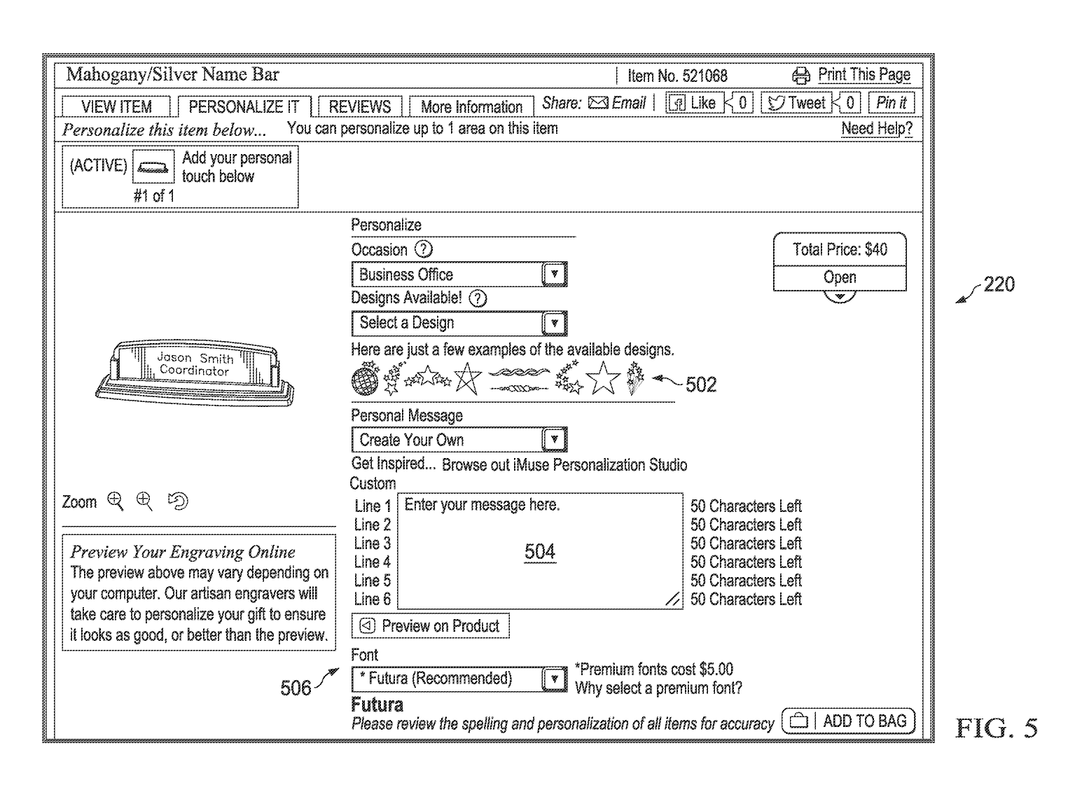

In some embodiments, the webpage 220 then displays customizing options for the chosen un-customized product. For example, a customer may choose a customized message to be engraved or embroidered on the un-customized product and/or a customized picture to being engraved, embroidered, printed or otherwise secured to the product. Other types of customization are within the scope of this disclosure, such as, but not limited to, color customization, size and shape customization, photograph customization, etc. In the exemplary webpage 220 illustrated in FIG. 5, for example, the customer can select one of various designs 502 and may enter various lines of text 504 to be engraved or embroidered on the un-customized product. In some embodiments, the customer can also choose the font 506 for the text of a chosen phrase. In some embodiments, the inventory server 208 or the store portal server 204 calculates an estimated completion time and date based on the un-customized product and customization options chosen by the customer. In some embodiments, the estimated completion time is a time on the same date as the date the purchase order is entered. In some embodiments, for example, the estimated completion time is between one and four hours after the time the purchase order is entered. In some embodiments, the estimated completion time is based in part on the operating hours of the chosen brick-and-mortar store so that the estimated completion time (and therefore the customer pickup time) falls within the store hours. In some embodiments, the webpage displays two or more estimated completion times to the customer to allow the customer to choose when he or she would like to pick up the customized product.

The customer then completes the purchase transaction on the webpage 220 by entering payment information and personal information. In some embodiments, complete payment is received online via the webpage 220 so that the customer has already paid for the product when the customer arrives at the brick-and-mortar store 205.

Referring again to FIGS. 3A and 3B, when the user finishes the order on the webpage 220, the web server 206 communicates the order details to the inventory server 208 and/or the store portal server 204. In some embodiments, the inventory server 208 sends a buy online sales transaction to the store portal server 204, as shown at block 306. In some embodiments, the buy online sales transaction includes a store identifier associated with the brick-and-mortar store 205 chosen by the customer, the uncustomized good and the customization options chosen by the customer.

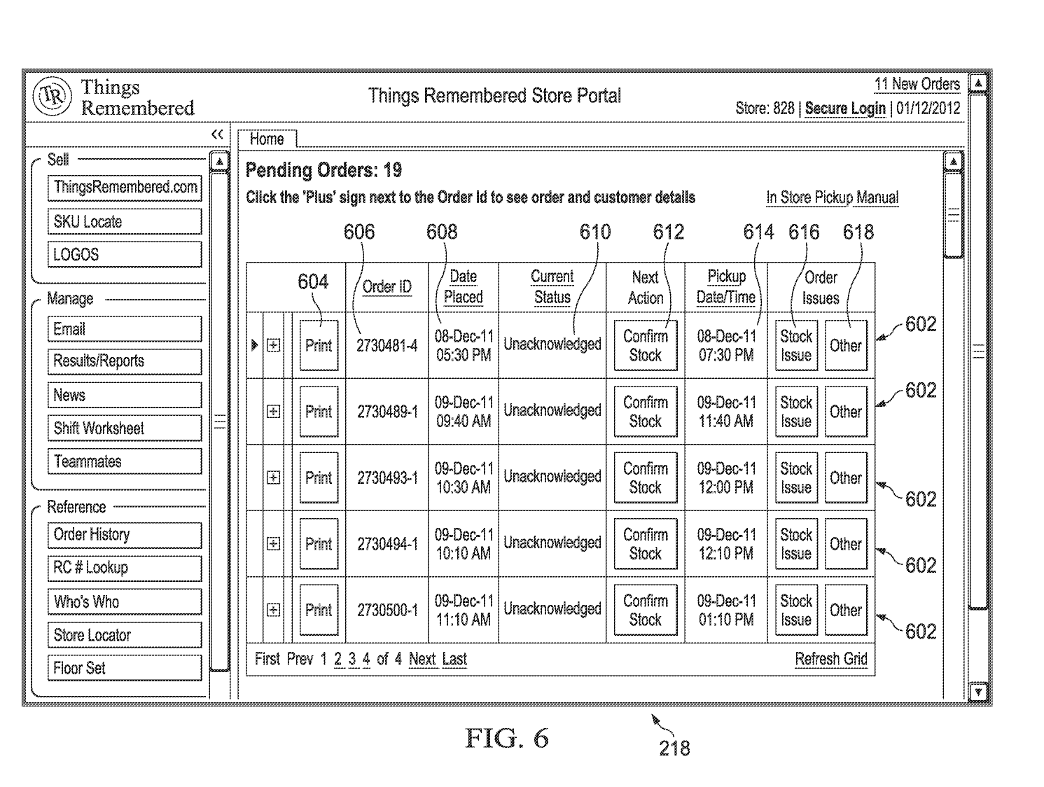

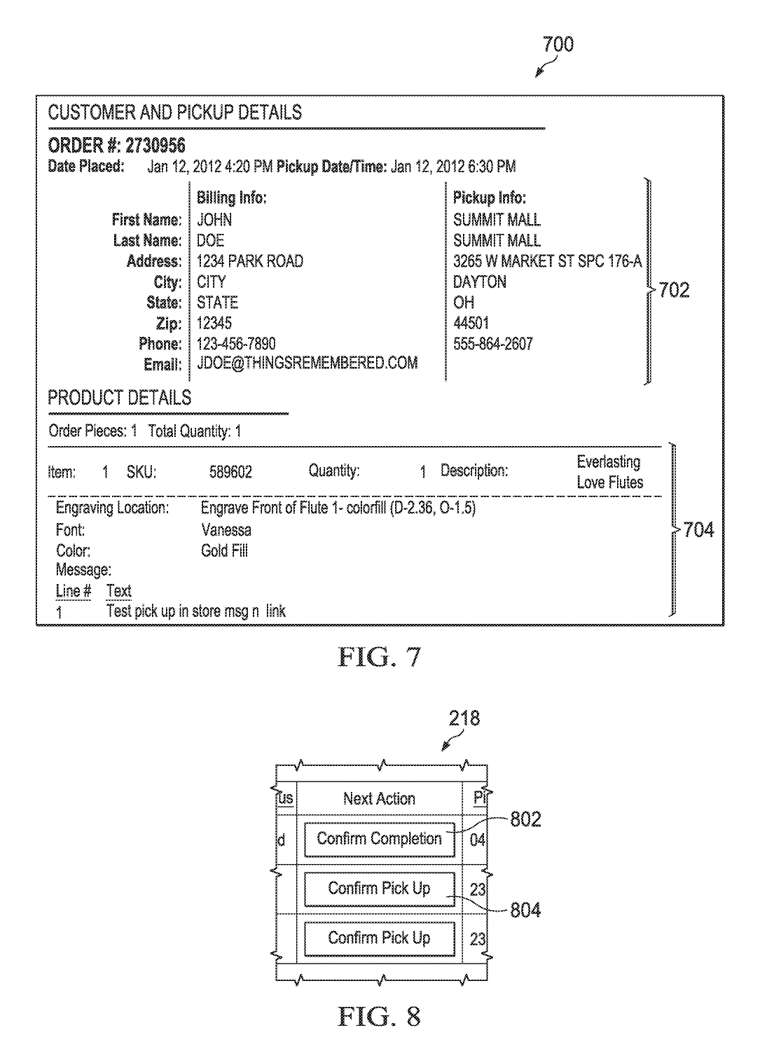

The store portal server 204 may display the buy online sales transaction on the suer interface 218. A brick and mortar store computing device 280 may display the user interface 218 via web browser 282. Referring now to the exemplary graphical user interface 218 of FIG. 6, the store's web browser 282 displays an order detail item 602 corresponding to the customer's order. The order detail item 602 may include a print option 604, an order ID 606, a date placed 608, the current status 610, a confirm stock option 612, a pickup date and time 614, a stock issue option 616, and an “other” option 618. Referring now to the embodiment illustrated in FIG. 7, a worker at the store chooses the print option 604 to print an order document 700 containing details concerning the online order. The document 700 may include information 702 concerning the customer, such as the customer's name, address, phone number and email address, and information 704 concerning the un-customized product such as a product name and type, and customization details for the product, such as a phrase to be engraved or embroidered on the product, the font for the phrase. The document 700 may also include a date and time that the customized product should be ready for pick-up. The worker in the store can then confirm receipt of the order and that the un-customized product from the customer order sheet 700 is actually in stock in the brick-and-mortar store 205 by selecting the confirm stock option 612 (FIG. 6) in the order detail item 602.

Referring again to FIGS. 3A and 3B, the store portal server 308 then sends an acknowledgment to the inventory server 208 that the buy online order transaction has been received and that the product is in stock, as shown at block 310. In some embodiments, if the store portal 308 does not acknowledge the order within a set period of time, such as, for example, 30 minutes, the portal server 204 automatically sends one or more automated phone calls or emails, such as at block 303, to a telephone or the user interface 218 displayed at the brick-and-mortar store 205, respectively. A worker at the store then again has the opportunity to acknowledge the order and confirm that the un-customized product is in stock by selecting the confirm stock option 612 (FIG. 6). If a worker at the store does not respond within a specified time period after the first automated voice call or email, the store portal server 308 automatically makes a follow-up voice call or sends a follow-up email to the brick and mortar store 205 or the user interface 218, respectively. This process may repeat as many times as desire. After a predetermined number of unanswered automated phone calls or emails, the inventory server 208 automatically prompts a live agent to call the brick-and-mortar store 205, as shown at block 341. The live agent instructs a worker at the brick-and-mortar store to check the user interface 218 for the new order. The worker then checks the inventory at the store to see if the product is available and selects the appropriate option on the user interface. Thus, the system 300 provides store personnel with automated acknowledgement and followup via computerized phone systems (and manual phone calls if the automated calls are not properly responded to). Many theoretically brilliant systems and procedures fail in the retail store environment because store personnel are high turnover participants whose attention is often lost due to excessive multitasking caused by unexpected customer requests. The foregoing reminder system provides for phone calls to help remind workers to check for new online purchase orders.

The worker at the store 205 then customizes the product in accordance with the details on the order detail document 700 and selects a confirm completion option 802 (FIG. 8) on the user interface 218. As discussed above, customizing the product may involve etching a phrase or symbol into the product, embroidering the product, printing on the product, or otherwise altering the product.

Referring again to FIG. 2, the portal server 204 or the inventory server 208 then sends a communication, such as an email similar to the email 900 shown in FIG. 9, to the customer computing device 202 to notify the customer that the product is available for pickup. In other embodiments, an automated phone call or text is sent to the customer's computing device 202. Referring again to FIGS. 3A and 3B, the store portal server 204 sends a store acknowledges buy online order completed message to the inventory server 304 as shown at block 312. The user then goes to the brick-and-mortar store 205 to pick up the customized product which is ready for immediate pick up. Thus, the foregoing system allows a customer to quickly obtain a customized good that is order online without incurring additional shipping costs. In some cases, the customized product is ready to be picked up within four hours of the customer's online purchase order. Referring again to FIG. 8, the worker at the store 205 then selects the confirm pickup option 804, and the store portal server 204 sends a store acknowledges buy online order pick-up message to the inventory server 208, as shown at block 314 of FIG. 3A.

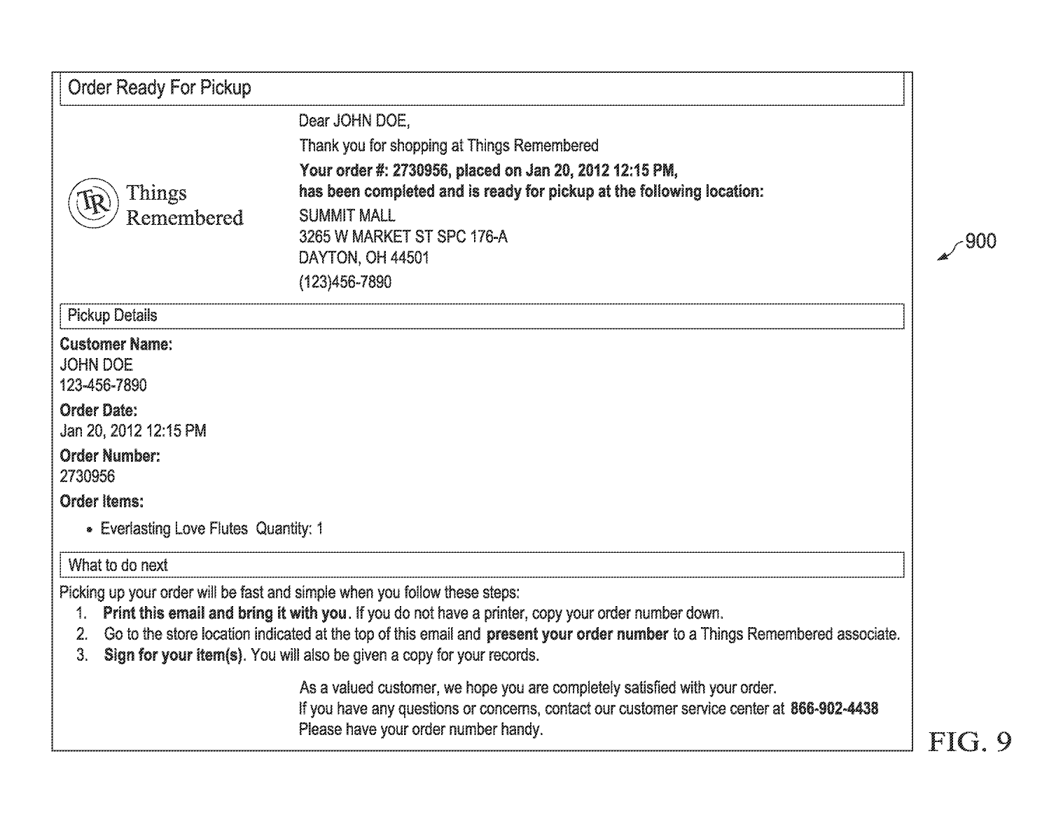

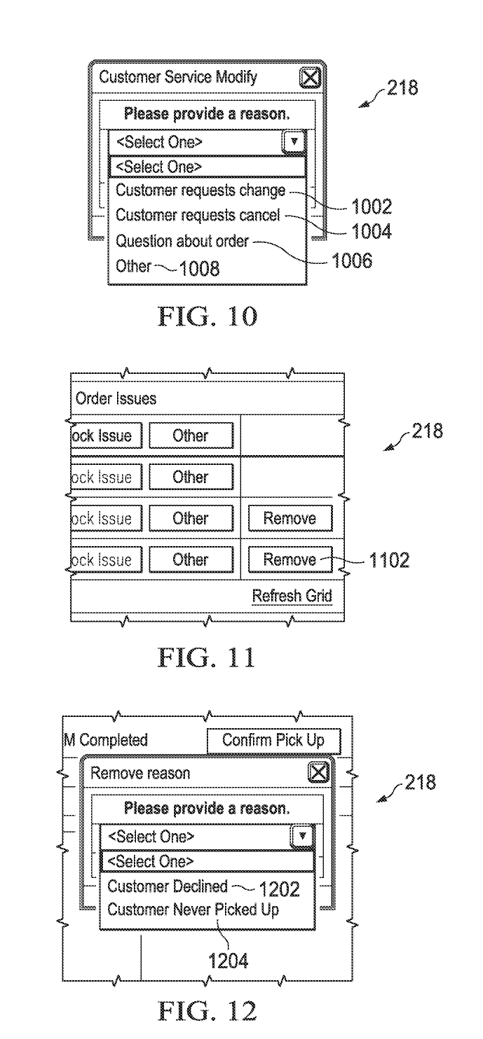

Referring again to FIG. 6, if there is an issue with the stock of a requested product, such as, for example, the requested un-customized product is not available at the chosen store 205, the store worker selects the stock issue option 616 and selects a reason for the stock issue, such as, referring now to FIG. 10, the customer requests a change 1002, the customer request to cancel 1004, the customer has questions about the order 1006, or some other reason 1008. Referring to FIG. 11, the worker at the store 205 then selects the remove option 1102 to remove the order. Referring again to FIGS. 3A and 3B, the store portal server 204 then sends a confirmation to the inventory server 208 that the order has been canceled, as shown at block 319. An automated message may also be sent to the customer's computing device 202 to alert the customer to the fact that the product is not in stock at the selected brick and mortar store.

Referring again to FIGS. 3A and 3B, the system 300 also includes an inventory control system. In some embodiments, the inventory server 208 sends an inventory status for one or more products to the web server 206 so that the webpage 220 displays updated information. In some embodiments, for example, the inventory server 208 sends an updated inventory periodically, such as, for example, every 15 minutes, to the web server 206 as shown at block 316. In some embodiments, a snapshot of the store perpetual inventory is taken nightly via batch from JDA and is decremented every 15 minutes by subtracting in store sales activity that occurs throughout the day. The store sales activity may be obtained via an ODBC connection to the store portal server 204 which is updated throughout the day via interfaces to individual store sales files at the point of sale. The store portal server 204 may also communicate with the inventory server 208 to report inventory, for example, in an inventory batch process as shown at block 319. In some embodiments, updates from the store portal server 204 are processed in near real time via the batch updates. Similarly, the inventory server 208 communicates return transactions with the store portal server 204, as shown at block 318.

In some embodiments, the inventory control system includes the ability to exclude certain stores with power outages, weather problems, staff shortages, overwhelming quantity demand or other features so that the store 205 does not appear as a possible brick-and-mortar store option 402 (FIG. 4) for customer pick up. In some embodiments, the inventory control system can also be configured to exclude certain products and/or require different minimum inventory quantities in order for a store 205 to appear as a possible brick-and-mortar store option 402 for customer pick up.

In some embodiments, a customized product that is ordered online may not be picked up within a certain amount of time, such as, for example, 30 days. As shown in FIGS. 3A and 3B, the inventory server 208 communicates with the store portal server 204 to notify the store 205 to generate a disposition as shown at block 320.

In some embodiments, data from the inventory server 208 and the store portal server 204 is stored in a data warehouse 214.

In some embodiments, the inventory control system includes a central order and fulfillment management system (CFM). The CFM generates an order for the portal server 204 when an order is received from the website 302 or web server 206. When inventory server 304 receives a store acknowledges buy online order completed at block 312, the CFM flags the order as awaiting pickup at block 326. A sales and inventory transaction is then generated in the JDA overnight at block 328. When the inventory server 304 receives a store acknowledges buy online order pickup at block 314, the CFM order is marked as picked up at block 330. The CFM then sends sales and customer data at block 332 (FIG. 3A) to the MBS 334 (FIG. 3A). The CFM also sends sales data with a store number to the data warehouse 214 at block 336 (FIG. 3B).

If the order is canceled, the CFM cancels the order section at block 338 and sends a message to the sales center to call the customer at block 340. If the canceled order is not settled at block 341, the CFM updates authorization with the new total at block 342. If the order cancellation is settled at block 341, a return CFM order is generated at block 344 and the sales and inventory transaction is generated in the date JDA overnight at block 346. Finally, an update is sent to the store portal database at block 348.

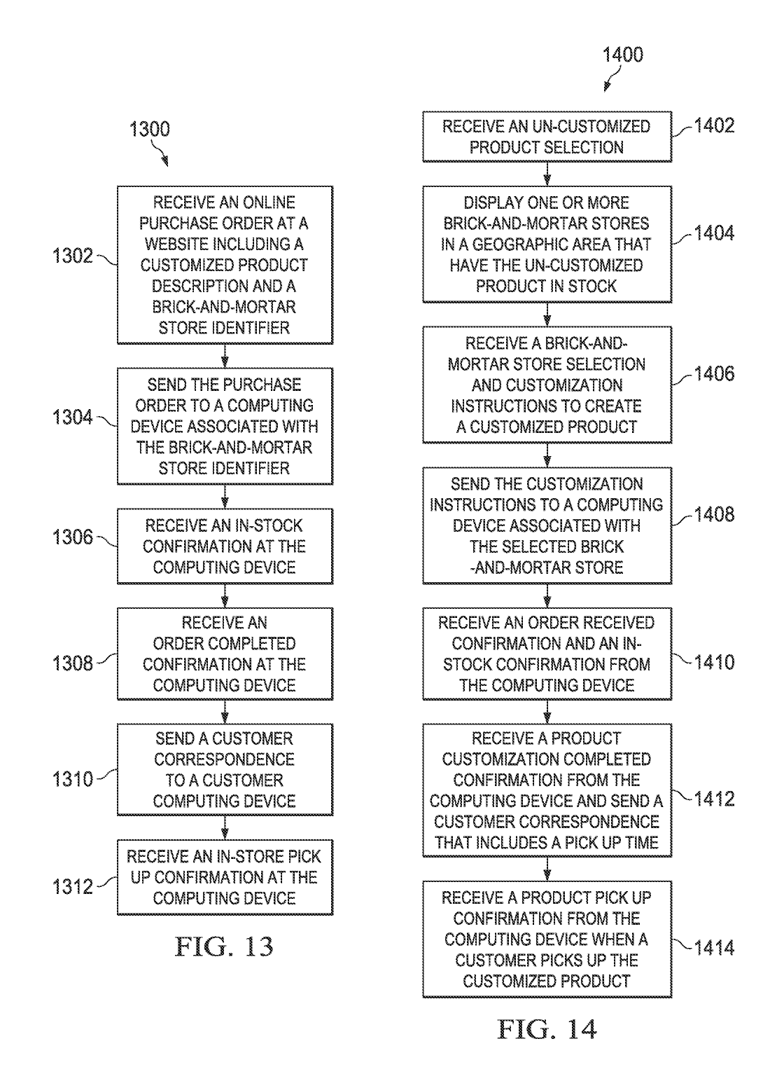

Referring now to FIG. 13, a flow chart illustrating an embodiment of a process 1300 for in-store pick up of customized goods ordered online is shown. At step 1302 an online purchase order is received at a web page 220 that includes a customized product description and a brick-and-mortar store identifier. At step 1304, the purchase order is sent to a computing device associated with the brick-and-mortar store identifier. At step 1306, an in-stock confirmation is received at the computing device and, at step 1308, an order completed confirmation is received at the computing device. A customer correspondence is send to a customer computing device at step 1310 and an in-store pick up confirmation is received at the computing device when a customer picks up the customized product, as shown at step 1312.

Referring now to FIG. 14, a flow chart illustrating an embodiment of a process 1400 for in-store pick up of customized goods ordered online is shown. In some embodiments, the process 1400 begins and an un-customized product selection is received at step 1402. At step 1404, one or more brick-and-mortar stores in a geographic area that has the un-customized product in stock are displayed. At step 1406, a brick-and-mortar store selection and customization instructions are received to create a customized product. At step 1408, the customization instructions are sent to a computing device associated with the selected brick-and-mortar store. At step 1410, an order received confirmation and an in-stock confirmation are received from the computing device. At step 1412, a product customization completed confirmation is received from the computing device and a customer correspondence that includes a pick up time is sent. At step 1414, a product pick up confirmation is received from the computing device when a customer picks up the customized product.

In the foregoing description of certain embodiments, specific terminology has been resorted to for the sake of clarity. However, the disclosure is not intended to be limited to the specific terms so selected, and it is to be understood that each specific term includes other technical equivalents which operate in a similar manner to accomplish a similar technical purpose.

In this specification, the word “comprising” is to be understood in its “open” sense, that is, in the sense of “including”, and thus not limited to its “closed” sense, that is the sense of “consisting only of”. A corresponding meaning is to be attributed to the corresponding words “comprise”, “comprised” and “comprises” where they appear.

In addition, the foregoing describes only some embodiments of the invention(s), and alterations, modifications, additions and/or changes can be made thereto without departing from the scope and spirit of the disclosed embodiments, the embodiments being illustrative and not restrictive.

Furthermore, invention(s) have been described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the invention(s). Also, the various embodiments described above may be implemented in conjunction with other embodiments, e.g., aspects of one embodiment may be combined with aspects of another embodiment to realize yet other embodiments. Further, each independent feature or component of any given assembly may constitute an additional embodiment.

What is claimed is:

1. A method, implemented in computer-executable program(s) or computer-executable instruction(s) in computer system(s) or device(s), comprising steps of:
receiving an online purchase order including a customized product description and a brick-and-mortar store identifier;
sending the online purchase order to a store portal server associated with the brick-and-mortar store identifier;
receiving an order received confirmation and an in-stock confirmation from the store portal server;
receiving an order completed confirmation from the store portal server;
sending a customer correspondence to a customer computing device, wherein the customer correspondence includes a product completed confirmation; and
receiving an in-store pick up confirmation from the store portal server.

2. The method of claim 1, further comprising sending an estimated completion time to the customer computing device before receiving the online purchase order.

3. The method of claim 1, further comprising sending an estimated completion time to the customer computing device after receiving the online purchase order.

4. The method of claim 1, wherein receiving an online purchase order further comprises a phrase for engraving on a product associated with the customized product description.

5. The method of claim 1, wherein receiving an online purchase order further comprises receiving one or more designs for engraving on a product associated with the customized product description.

6. The method of claim 1, wherein receiving an online purchase order further comprises receiving an un-customized product selection.

7. The method of claim 1, further comprising receiving a customer location and determining one or more store identifiers within a specified geographic distance of the customer location.

8. The method of claim 1, further comprising calculating an estimated pickup time that is within operating hours of a brick-and-mortar store associated with the brick-and-mortar store identifier.

9. The method of claim 1, further comprising calculating an estimated pickup time based on a time to complete customization associated with the customized product description.

10. A method of enabling in-store pickup of customized goods ordered online, the method comprising:
receiving an un-customized product selection from a web server;
receiving a customer location from the web server;
sending information concerning one or more brick-and-mortar stores within a geographic distance of the customer location that have the un-customized product in stock to the web server;
receiving a brick-and-mortar store selection and customization instructions to create a customized product;
sending the customization instructions to a store portal server associated with the selected brick-and-mortar store;
receiving an order received confirmation and an in-stock confirmation from the store portal server.

11. The method of claim 10, further comprising receiving a product customization complete confirmation from the store portal server.

12. The method of claim 11, further comprising sending a customer correspondence comprising a product ready indication to a customer computing device.

13. The method of claim 10, further comprising receiving a product pick up confirmation from the store portal server when a customer picks up a customized product.

14. The method of claim 10, further comprising sending an estimated completion time to a customer computing device.

15. The method of claim 12, further comprising calculating the estimated completion time based on the customized product.

16. A method of enabling in-store pickup of customized goods ordered online, the method comprising:
receiving an un-customized product selection at a website server;
receiving a customizing selection for the un-customized product at the website server;
receiving a user location designation at the website server;
sending data concerning one or more brick-and-mortar store identifiers that have the un-customized product in stock and are within a specified geographic distance of the user location designation to the website server;
customizing an un-customized product associated with the un-customized product selection to include the customizing selection; and
sending an order ready for pick-up message to a user computer device.

17. The method of claim 16, further comprising receiving at an inventory server a product in stock confirmation from a brick-and-mortar store associated with the brick-and-mortar store identifier.

18. The method of claim 16, wherein customizing the un-customized product comprises etching the un-customized product.

19. The method of claim 16, wherein customizing the un-customized product comprises embroidering the un-customized product.

20. The method of claim 16, further comprising calculating an estimated pickup time that is within operating hours of a brick-and-mortar store associated with the brick-and-mortar store identifier.
